(19) United States
(12) Patent Application Publication
(10) Pub. No.: US 2008/0076048 A1
(43) Pub. Date: Mar. 27, 2008

(54) Photoconductive switching element, photo-writing type recording medium, and their production method and utilization

(75) Inventors: Hiroshi Arakatsu, Minami-Ashigara-Shi (JP); Takehito Hikichi, Ebina-Shi (JP)

Correspondence Address: BIRCH STEWART KOLASCH & BIRCH, PO BOX 747, FALLS CHURCH, VA, 22040-0747, US

(73) Assignees: FUJIFILM Corporation; Fuji Xerox Co., Ltd.

(21) Appl. No.: 11/902,318

(22) Filed: Sep. 20, 2007

(30) Foreign Application Priority Data
Sep. 21, 2006 (JP) 2006-256248

(51) Int. Cl. G03G 5/043; G03G 15/00

(52) U.S. Cl. 430/57.2; 399/159; 430/133

(57) ABSTRACT

A method for producing a photoconductive switching element for switching a functional element to be driven by an AC field or a DC field, in which the photoconductive switching element comprises an electrode layer, a lower charge generation layer, a charge transport layer and an upper charge generation layer laminated in that order on a substrate, which comprises forming at least one layer to be laminated above the electrode layer by the use of a solvent system that comprises a solvent capable of swelling or dissolving the layer just below the layer to be laminated.

### BACKGROUND OF THE INVENTION

1. Field of the Invention

The present invention relates to a photoconductive switching element and a device such as a photo-writing type recording medium using it, and to a display device and a writing device.

2. Description of the Related Art

In recent years, a photo-writing type space modulation device having a photoconductive switching element and a display element in combination has been developed and put to practical use in projector, etc. as a light bulb, and its applicability to the art of optical data processing has been studied as described in “Liquid Crystal Space Modulator and Data Processing”, Liquid crystal, vol. 2, No. 1, 1998, pp. 3-18. While a predetermined voltage is being applied to the display element therein, the photo-writing type space modulation device changes the impedance of the photoconductive switching element according to the amount of light that it has received and controls the voltage applied to the display element to drive the display element so that an image is displayed thereon. In particular, a separable photo-writing type recording medium, which is a photo-writing type space modulation device employing a display controlling element having memory properties, has attracted attention as an electronic paper medium.

As a display controlling element for photo-writing type recording medium, for example, there have been studied liquid crystal display elements such as nematic liquid crystal which has been dispersed in a polymer to have memory properties, cholesteric liquid crystal and ferroelectric liquid crystal, and electrophoretic elements, electric field rotation elements, toner electric field transfer elements, capsule elements obtained by encapsulating these elements, etc. As photoconductive switching elements capable of controlling voltage or current according to the amount of light that they have received, for example, known are amorphous silicon elements, OPC elements having a function-separated dual-layer structure that comprises an organic photoconductor, etc. Further known are OPC elements that comprise a charge generation layer (CGL) formed on the upper and lower sides of a charge transport layer (CTL) (hereinafter referred to as “dual CGL structure”) (JP-A-2000-180888). In particular, OPC elements require no high temperature heat treatment and are therefore applicable to flexible substrates such as PET films, and in addition, they do not require a vacuum process and therefore have another advantage in that they can be produced at low costs. Among the foregoing structures, the dual CGL structure can be driven by an A.C. voltage. Even when a liquid crystal element is used as a display element, the bias component contained in the voltage applied prevents the displayed image from being burn-in due to ion transfer. Accordingly, the dual CGL structure is a very useful structure. FIG. 1 is a conceptual view of a photo-writing type electronic paper with the photoconductive switching element applied thereto.

For forming the charge generation layer to be in the photoconductive switching element, employable is a vacuum process of vapor evaporation or sputtering on a support or a coating process of applying a dispersion of at least a binder resin, a charge-generating material and its solvent, onto a support. The vacuum process requires an expensive apparatus and therefore it could hardly produce low-price media. On the other hand, the coating process enables inexpensive mass-scale production, and is advantageous in point of its cost. Accordingly, the coating process is now specifically noted as a method for forming a charge generation layer. In particular, a spraying method and its modification, an inkjet method, as well as a curtain-coating method, a bar-coating method and a die-coating method are more specifically noted because of their possibility of continuous coating.

For producing a photoconductive switching element according to such a continuous coating process, the adhesiveness between the adjacent coating layers must be fully increased. In case where the adhesiveness is insufficient, then the coating layers may undergo delamination during their formation, therefore causing coating failure. Differing from that in batch coating treatment, the time to be taken from coating to drying in the continuous coating treatment is short, and therefore the interlayer adhesiveness between the adjacent coating layers may lower. In particular, in producing a photoconductive switching element, a different binder must be used individually for every coating layer and therefore each layer must be formed with a different solvent individually for it; and in such a case, the interlayer adhesion insufficiency is often problematic.

Contrary to the present invention, JP-A-2002-196291 discloses a technique of specific solvent selection of such that the solvent in the upper coating layer does not invade the binder in the just underlying layer whereby the interlayer boundary between the two layer is smoothed and the performance of the structure is thereby improved. However, continuous coating is not taken into consideration in this method, and it has been found that, when the method is applied to a continuous coating technique, then interlayer adhesion failure occurs frequently, therefore causing many problems of layer delamination during coating, layer delamination during blanking in device construction, and layer delamination in a repeated bending test of devices.

For solving the problem of general adhesion failure, there may be employed a method of surface roughening through electrical treatment such as corona treatment or plasma treatment, or a method of forming an active group (e.g., ionic group, radical) on the surface of a coating layer and chemically or electrostatically bonding it to the binder in the overlying layer. These methods are general methods for treatment of supports, in which, however, the adhesiveness may lower with the lapse of time after the treatment or the treatment may be often uneven, and therefore even when an overlying layer is formed immediately after the treatment, the interlayer adhesiveness capability may be often uneven. In addition, the corona treatment is extremely difficult to attain on a photoconductive layer-having support from the viewpoint of electric insulation.

Another ordinary method for solving the problem of adhesion failure is described. This comprises applying a chemical capable of forming a chemical bond (crosslinker) both to the binder in a lower layer and to the binder in an upper layer so that the crosslinker may form an interlayer bond to thereby improve the interlayer adhesiveness between the two layers. This method requires any of (A) a step of introducing a functional group capable of reacting with the crosslinker, into the binder of the upper layer and the lower layer, and (B) a step of introducing a functional group capable of reacting with the crosslinker, into the polymer compatible with the binder in the upper layer and the lower layer, and further requires an additional step of separately applying the crosslinker to the lower layer before the formation of the upper layer thereon, and therefore the method is problematic in that it increases the material costs and increases the number of the necessary working steps.

Still another ordinary method for solving the problem of adhesion failure is described. This comprises using a block polymer compatible with the binder of the upper layer and the lower layer. In this method, the upper and lower layers are bonded to each other by the block polymer, and therefore, the method is effective when the block polymer-containing layer is provided between the upper and lower layers or when the block polymer is introduced into one or both of the upper and lower layers. In this method of using the block polymer, in addition, the film thickness shall increase by the amount of the block polymer used, therefore causing the deterioration of the device characteristics or the reduction in the deformation resistance of device products. Moreover, in this, it is often difficult to ensure the solubility of the block copolymer, therefore causing another problem of production cost increase. Further, it is now desired in the art to further improve the interlayer adhesiveness more than that in those methods.

### SUMMARY OF THE INVENTION

The present invention has been made in consideration of the above-mentioned problems, and its object is to provide a technique of solving a problem of interlayer adhesion failure in producing a photoconductive switching element according to a continuous lamination coating method at low cost and at high speed. The invention is also to provide a device comprising the photoconductive switching element and having an excellent function, in particular, a photo-writing type recording medium.

The above objects are attained by providing a photoconductive switching element and its production method, a device, a photo-writing type recording medium, a display device and a writing device that are described below.

(1) A method for producing a photoconductive switching element for switching a functional element to be driven by an AC field or a DC field, in which the photoconductive switching element comprises an electrode layer, a lower charge generation layer, a charge transport layer and an upper charge generation layer laminated in that order on a substrate, which comprises forming at least one layer to be laminated above the electrode layer by the use of a solvent system that comprises a solvent capable of swelling or dissolving the layer just below the layer to be laminated.

The photoconductive switching element is so designed that at least one constitutive layer thereof is formed of a coating liquid that contains a solvent capable of swelling or dissolving the layer just below that layer, and therefore, it may be produced at low cost. In this, in addition, the charge generation layer and the charge transport layer may swell or dissolve the layer just below it while it is formed on the underlying layer, and therefore the overlying layer may physically roughen the interface to the underlying layer or may form binder entanglement between the two layers, thereby increasing the interlayer adhesiveness of the structure.

(2) The method for producing a photoconductive switching element of (1), wherein the lower charge generation layer is positioned just below the charge transport layer, and the charge transport layer is formed by the use of a solvent system that comprises a solvent capable of swelling or dissolving the lower charge generation layer.

(3) The method for producing a photoconductive switching element of (2), wherein the charge transport layer comprises a charge-transporting material that comprises, as the main ingredient thereof, a benzidine compound and/or a triphenylamine compound, and a binder that comprises a polycarbonate resin as the main ingredient thereof, and the solvent system to be used in forming the charge transport layer comprises, as the main solvent thereof, at least one solvent selected from the group consisting of toluene, xylene, methylene chloride, dichloroethane, monochlorobenzene, tetrahydrofuran, cyclohexanone and cyclopentanone, and comprises, as the solvent capable of swelling or dissolving the lower charge generation layer, at least one solvent selected from the group consisting of methylene chloride, chloroform, chloroethylene, tetrahydrofuran and trichloroethylene.

(4) The method for producing a photoconductive switching element of any one of (1) to (3), wherein the charge transport layer is positioned just below the upper charge generation layer, and the charge generation layer is formed by the use of a solvent system that comprises a solvent capable of swelling or dissolving the charge transport layer.

(5) The method for producing a photoconductive switching element of (4), wherein the upper charge generation layer comprises a charge-generating material that comprises, as the main ingredient thereof, at least one compound selected from the group consisting of chlorogallium phthalocyanine, hydroxygallium phthalocyanine and titanylphthalocyanine, and a binder resin that comprises, as the main ingredient thereof, at least one compound selected from the group consisting of a polyvinylbutyral resin, a polyvinylformal resin, a polyvinyl acetal resin and an alcohol-soluble nylon, and the solvent system to be used in forming the upper charge generation layer comprises n-butanol as the main solvent thereof, and comprises, as the solvent capable of swelling or dissolving the charge transport layer, at least one solvent selected from the group consisting of methylene chloride, chloroform, chloroethylene, trichloroethylene, toluene, xylene, cyclohexanone, methyl ethyl ketone and tetrahydrofuran, in an amount of at least 5% by mass of the overall solvent amount.

(6) A photoconductive switching element produced by the method of any one of (1) to (5).

(7) A device comprising the photoconductive switching element of (6) and a functional element thereof electrically connected to the photoconductive switching element.

Combining the photoconductive switching element with various functional elements gives devices that have display capabilities on the same level as that of conventional devices and have excellent interlayer adhesiveness and excellent bending resistance at high producibility and at low cost.

(8) A photo-writing type recording medium which comprises an electrode, a display layer, a photoconductive switching element and an electrode laminated between a pair of substrates; wherein the photoconductive switching element is the photoconductive switching element of (6), and the upper charge generation layer of the element is positioned on the display layer side, and the substrate and the electrode at least on the side on which writing light runs into it are transmissive to light.

The photo-writing type recording medium of the invention comprises the above-mentioned photoconductive switching element, and is therefore free from a problem of yield depression owing to interlayer adhesion failure and a problem of medium breakage owing to delamination by bending in use of the medium.

(9) A method for producing a photo-writing type recording medium for AC-driving system, which comprises forming a charge-generating material-containing lower charge generation layer, a charge-transporting material-containing charge transport layer, and a charge-generating material-containing upper charge generation layer in that order to form a photoconductive switching layer on the surface of an electrode layer formed on a substrate, wherein each of the lower charge generation layer, the charge transport layer and the upper charge generation layer is formed by the use of a solvent system comprising a solvent capable of swelling or dissolving the layer just below the coating layer; forming a display element layer on the surface of the transparent electrode layer of a transparent substrate having the transparent electrode layer formed thereon; and laminating the thus-obtained two substrates in such a manner that the photoconductive switching layer and the display element layer could face each other.

(10) A display device comprising the photo-writing type recording medium of (8), a recording medium-driving unit for driving the recording medium, a photo-writing unit for photo-writing on the recording medium, and a control unit.

(11) A writing device comprising the photo-writing type recording medium of (8), a recording medium-driving unit for driving the recording medium, a photo-writing unit for photo-writing on the recording medium, and a control unit.

According to the invention, a photoconductive switching having improved adhesiveness at the interlayer of lower charge generation layer/charge transport layer and that of charge transport layer/upper charge generation layer, and having excellent workability and durability can be produced in a mode of continuous coating lamination at low cost and at high speed. Combining the photoconductive switching element with various functional elements gives devices having more excellent properties (e.g., photo-writing type recording medium).

### BRIEF DESCRIPTION OF THE DRAWINGS

FIG. 1 is a conceptual view showing a cross section of a photoconductive switching element having a dual CGL structure.

FIG. 2 is a schematic view showing one example of the photo-writing type recording medium of the invention.

FIG. 3 is a schematic view showing one example of the writing device and the display device of the invention.

In the drawings, 10 is a substrate, 12 is an electrode, 14 is a lower charge generation layer, 16 is a charge transport layer, 18 is an upper charge generation layer, 20 is a photo-writing type recording medium, 30 is a photoconductive switching element, 40 is a display element, 50 is a functional film (or a separation layer), 65 is a connector, 70 and 82 each are a control unit, 84 is an optical pattern formation unit, 86 is a light emission unit, A is a control unit, B is a recording medium driving unit, C is a photo-writing unit.

### BEST MODE FOR CARRYING OUT THE INVENTION

The method for producing a photoconductive switching element of the invention is described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

Basically, the photoconductive switching element of the invention comprises a light-transmissive substrate, a light-transmissive electrode layer, a lower charge generation layer, a charge transport layer and an upper charge generation layer. In the invention, a property of “transmissive to light” may be expressed as “transparent”.

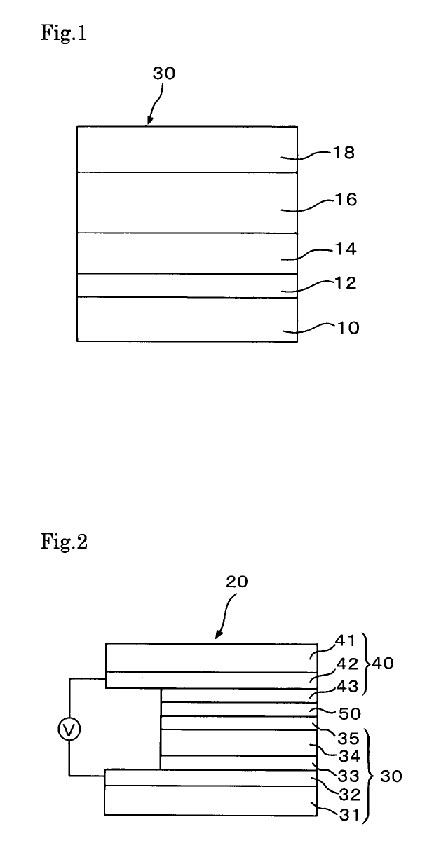

FIG. 1 shows a structure of a photoconductive switching element 30 of the invention (this is a dual CGL structure-having photoconductive switching element). In FIG. 1, 10 is a substrate, 12 is a conductive film (electrode), 14 is a lower charge generation layer, 16 is a charge transport layer, 18 is an upper charge generation layer. The upper charge generation layer is positioned on the side of the functional layer, for example, the display layer in the device or the photo-writing medium described hereinunder.

As the charge-generating material in the lower and upper charge generation layers, usable is an organic material capable of generating a charge through irradiation with light, such as perylene compounds, phthalocyanine compounds, bisazo compounds, dithiopitokeropyrrole compounds, squarylium compounds, azulenium compounds, thiapyrylium compounds polycarbonate compounds. In particular, chlorogallium phthalocyanine, hydroxygallium phthalocyanine and titanylphthalocyanine are preferred as a high-sensitivity charge-generating material. Of those, more preferred are (1) chlorogallium phthalocyanine of which the X-ray diffraction spectrum of the crystal structure has a strong diffraction peak at a Bragg angle (2θ±0.2°) of at least i) 7.4°, 16.6°, 25.5° and 28.3°, ii) 6.8°, 17.3°, 23.6° and 26.9°, or iii) 8.7° to 9.2°, 17.6°, 24.0°, 27.4° and 28.8°; (2) hydroxygallium phthalocyanine of which the X-ray diffraction spectrum of the crystal structure has a strong diffraction peak at a Bragg angle (2θ+0.2°) of at least i) 7.5°, 9.9°, 12.5°, 16.3°, 18.6°, 25.1° and 28.3°, ii) 7.7°, 16.50, 25.1° and 26.6°, iii) 7.9°, 16.5°, 24.4° and 27.6°, iv) 7.0°, 7.5°, 10.5°, 11.7°, 12.7°, 17.3°, 18.1°, 24.5°, 26.2° and 27.1°, v) 6.8°, 12.8°, 15.8° and 26.0°, or vi) 7.4°, 9.9°, 25.0°, 26.2° and 28.2°; and (3) titanylphthalocyanine of which the X-ray diffraction spectrum of the crystal structure has a strong diffraction peak at a Bragg angle (2θ±0.2°) of at least i) 9.3° and 26.3°, or ii) 9.5°, 9.7°, 11.7°, 15.0°, 23.5°, 24.1° and 27.3°, as they have a high sensitivity. At least one or more charge-generating materials selected from those groups may be used herein.

As the binder resin in the lower and upper charge generation layers, usable are a polyvinylbutyral resin, a polyarylate resin, a polyester resin, a phenoxy resin, a vinyl chloride-vinyl acetate resin, a carboxyl-modified vinyl chloride-vinyl acetate copolymer, a polyamide resin (including nylon resin), an acrylic resin, a polyacrylamide resin, a polyvinylpyridine resin, a cellulose resin, an urethane resin, an epoxy resin, casein, a polyvinyl alcohol resin, a polyvinylpyrrolidone resin, etc. In particular, a polyvinylbutyral resin and a polyamide resin, especially a nylon resin such as methoxymethylated 6-nylon are effective as soluble in many alcohols and ketoalcohols. In addition, a carboxyl-modified vinyl chloride-vinyl acetate copolymer is also preferred as the binder resin, since it is soluble in ketoalcohols and may well disperse a charge-generating material, hydroxygallium phthalocyanine therein.

For forming the lower charge generation layer, employable is a dry film formation method such as a vacuum evaporation method or a sputtering method; however, a wet coating method that uses a solution or a dispersion is preferred. The wet coating method may be any ordinary coating method or printing method, and is preferably a bar coating method, a die coating method, a gravure coating method, a spraying method, an inkjet coating method, a curtain coating method, a spin coating method or a dipping method. Above all, a bar coating method, a die coating method or a gravure coating method is more preferred for rapid continuous film formation. All these methods do not require substrate heating or severe process control as in a-Si or photodiode formation. The thickness of the upper and lower charge generation layers is preferably from 10 nm to 1 μm, more preferably from 20 nm to 500 nm. When it is thinner than 10 nm, then the photosensitivity of the layer may be insufficient and uniform film formation may be difficult; and when thicker than 1 μm, then the photosensitivity may be saturated and the film may be delaminated owing to the inner stress.

As the charge-transporting material, usable are benzidine compounds, trinitrofluorene compounds, polyvinylcarbazole compounds, oxadiazole compounds, pyrazoline compounds, hydrazone compounds, stilbene compounds, triphenylamine compounds, triphenylmethane compounds, etc. More preferred are benzidine compounds. Also usable are ion-conductive materials such as LiClO₄-added polyvinyl alcohol and polyethylene oxide.

As the binder resin in the charge transport layer, usable are a polycarbonate resin, a polyester resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone-alkyd resin, a phenol-formaldehyde resin, a styrene-alkyd resin, a poly-N-vinylcarbazole, a polysilane, etc. In particular, a polycarbonate resin is extremely effective as the binder, since it improves the properties of the charge-transporting material combined with it.

For forming the charge transport layer, employable is a dry film formation method such as a vacuum evaporation method or a sputtering method; however, a wet coating method that uses a solution or a dispersion is preferred. The wet coating method may be any ordinary coating method or printing method, and is preferably a bar coating method, a die coating method, a gravure coating method, a spraying method, an inkjet coating method, a curtain coating method, a spin coating method or a dipping method. Above all, a bar coating method, a die coating method or a gravure coating method is more preferred for rapid continuous film formation. The thickness of the charge transport layer is preferably from 0.1 μm to 100 μm, more preferably from 1 μm to 10 μm. When it is thinner than 0.1 μm, then the withstand voltage of the layer may lower and reliability security may be difficult; and when thicker than 100 μm, then the impedance matching with functional elements may be difficult and the layer planning may be therefore difficult.

The production method for the photoconductive switching element of the invention is characterized in that the constitutive layers including the charge generation layer and the charge transport layer are formed from a coating liquid that containing a solvent capable of swelling or dissolving the underlying layer just below the coating layer. The constitutive layers as referred to herein include the charge generation layer, the charge transport layer, as well as all other functional layers such as an adhesion-improving layer, a light-shielding layer, a coloring layer, an insulating layer, a functional layer for direct current component removal, etc. The order of those layers to be disposed is not specifically defined, except for the order of the conductive layer, the charge generation layer, the charge transport layer and the charge generation layer; and between those four layers, any functional layer may be disposed. Apart from these four layers, additional conductive layer, charge transport layer and charge generation layer may also be disposed. The underlying layer just below the coating layer is meant to indicate the layer with which the coating layer is directly contacted during its formation; and after dried, the coating layer shall form an interface or a transition region along with the underlying layer. The transition region is meant to indicate a region in which the constitutive ratio of the constitutive components of the two layers that are adjacent to each other in lamination to have a predetermined width (thickness) continuously changes.

The solvent that swells the directly underlying layer is a solvent of such that, when a single film of the underlying layer is dipped in the solvent for 5 minutes, then its mass increase measured after the dipping is at least 3%; and the solvent that dissolves the directly underlying layer is a solvent of such that, when a single film of the underlying layer is dipped in the solvent for 1 day, then it may dissolve in the solvent to a concentration of at least 1% of the overall solvent amount.

The amount of the solvent capable of swelling or dissolving the underlying layer is suitably at least 3% by mass of the overall solvent amount, though varying depending on the ability and the speed of the solvent to swell or dissolve the underlying layer; preferably from 5% by mass to 80% by mass, more preferably from 7% by mass to 50% by mass. When the amount is at most 80% by mass, then the underlying layer may not be too much swollen or dissolved and the interface smoothness may not too much lower, or the transition layer may not too much grow, or the layer may not be a uniform layer to degrade the element performance.

In the invention, for the solvent to be used in forming the charge generation layer, alcohols, ketones, ethers and esters are generally effective, though depending on the material that constitutes the charge transport layer. Above all, a solvent having a hydroxyl group in the molecule, such as alcohols, is most preferred as the solvent for the dispersion for the charge generation layer to be formed on the charge transport layer that comprises a polycarbonate resin as the binder therein. The solvent to be used in forming the charge generation layer in the invention is preferably a protic solvent and its solubility parameter (SP value) is preferably at least 18 (MPa). In general, a substance that is insoluble or hardly soluble in a protic solvent such as alcohol is much used as the charge-transporting material. On the other hand, a resin compatible with a charge-transporting material is selected for the binder resin in the charge transport layer; and regarding its solubility, the resin is so selected that it has properties similar to those of the charge-transporting material, or that is, the resin is insoluble or hardly soluble in a protic solvent. In general, the solubility parameter of the binder resin to be used in the charge transport layer is from 16 to 18 (MPa)^{0.5} or so, and therefore, for increasing the poor solubility thereof, the solvent preferably has an SP value of at least 18 (MPa)^{0.5}.

In case where a constitution that has a charge transport layer just below a charge generation layer is employed for the element of the invention and when the above-mentioned solvent includes those capable of swelling or dissolving the charge transport layer, then the solvent may be used as a single solvent for the constitution. However, as so mentioned in the above, the range of the SP value of the solvent to be used in the charge transport layer and that of the solvent to be used in the charge generation layer do not overlap with each other in many cases, and it is rare that one and the same solvent can swell or dissolve both the two layers. In particular, it is extremely rare that the solvent of a charge generation layer could swell or dissolve a charge transport layer. In such a case, the effect of the invention can be realized by adding a coating solvent for a charge transport layer or a solvent capable of swelling or dissolving a charge transport layer to the layer-forming liquid.

Concretely, in case where the upper charge generation layer contains a charge-generating material that comprises, as the main ingredient thereof, at least one compound selected from the group consisting of chlorogallium phthalocyanine, hydroxygallium phthalocyanine and titanylphthalocyanine, and a binder resin that comprises, as the main ingredient thereof, at least one compound selected from the group consisting of a polyvinylbutyral resin, a polyvinylformal resin, a polyvinyl acetal resin such as a partially-acetallized polyvinylbutyral resin in which a part of the butyral resin moiety is modified with formal or acetoacetal, and an alcohol-soluble nylon, then the solvent system to be used in forming the upper charge generation layer preferably comprises n-butanol as the main solvent thereof, and contains, as the solvent capable of swelling or dissolving the charge transport layer, at least one solvent selected from the group consisting of methylene chloride, chloroform, chloroethylene, trichloroethylene, toluene, xylene, cyclohexanone, methyl ethyl ketone and tetrahydrofuran, in an amount of at least 5% by mass of the overall solvent amount.

The alcohol applicable to the charge generation layer is a compound having at least one hydroxyl group in the molecule, including, for example, methanol, ethanol, 1-propanol, 2-propanol, 1-butanol, 2-butanol, isobutyl alcohol, tert-butyl alcohol, 1-pentanol, 2-pentanol, 3-pentanol, 2-methyl-1-butanol, isopentyl alcohol, tert-pentyl alcohol, 3-methyl-2-butanol, neopentyl alcohol, 1-hexanol, 2-methyl-1-pentanol, 4-methyl-2-pentanol, 2-methyl-1-butanol, 1-heptanol, 2-heptanol, 3-heptanol, 1-octanol, 2-octanol, 2-ethyl-1-hexanol, 1-nonanol, 3,5,5-trimethyl-1-hexanol, 1-decanol, 1-undecanol, 1-dodecanol, allyl alcohol, propargyl alcohol, benzyl alcohol, cyclohexanol, 1-methylcyclohexanol, 2-methylcyclohexanol, 3-methylcyclohexanol, 4-methylcyclohexanol, α-terpineol, abietinol, fusel oil, 1,2-ethanediol, 1,2-propanediol, 1,3-propanediol, 1,3-butanediol, 1,2-butanediol, 1,4-butanediol, 2,3-butanediol, 1,5-pentanediol, 2-butene-1,4-diol, 2-methyl-2,4-pentanediol, 2-ethyl-1,3-hexanediol, glycerin, 2-ethyl-2-(hydroxymethyl)-1,3-propanediol, 1,2,6-hexanetriol.

In addition, a compound having a hydroxyl group and a carbonyl group in the molecule is also effective and is applicable to the layer, including, for example, ketoalcohols such as 3-methyl-3-hydroxy-2-butanone, 4-methyl-4-hydroxy-2-pentanone.

Needless-to-say, a few types of these solvents may be combined together, and may also be combined optionally along with any other solvent so far as they are the main ingredient of the combined mixture.

As the solvent to be used in forming the charge transport layer in the invention, in general, a chlorine-containing solvent, an aromatic solvent and an ether solvent are effective. Of those, a chlorine-containing and a ketone-type aromatic solvent may dissolve both a charge-transporting material and a binder at high concentration, and are therefore most preferred as the solvent for a coating liquid for charge transport layer formation. Preferably, the solvent to be used in forming the charge transport layer in the invention has a solubility parameter (SP value) of at least 18 (MPa)^{0.5}.

An embodiment of forming a charge transport layer just above a charge generation layer is described. There are known many chlorine-containing solvents capable of swelling or dissolving the charge generation layer. When such a chlorine-containing solvent is used as the main solvent in the case, then it may be used alone to realize the effect of the invention. On the contrary, however, there may be a possibility that the single use of the solvent of the type may too much swell or dissolve the charge generation layer during the process of forming and drying the charge transport layer, and in such a case, a solvent that hardly swells or dissolves the charge generation layer, such as tetrahydrofuran, cyclohexanone or cycloheptanone, must be added to the above essential solvent so as to retard the swelling or dissolution of the charge generation layer.

Concretely, in case where the charge transport layer contains a charge-transporting material that comprises, as the main ingredient thereof, a benzidine compound and/or a triphenylamine compound, and contain a binder that comprises a polycarbonate resin as the main ingredient thereof, then the solvent to be used in forming the charge transport layer is preferably a solvent system that comprises, as the main solvent, at least one solvent selected from the group consisting of toluene, methylene chloride, dichloroethane, monochlorobenzene, tetrahydrofuran, cyclohexanone and cyclopentanone, and contains, as the solvent capable of swelling or dissolving the underlying charge generation layer, at least one solvent selected from the group consisting of methylene chloride, chloroform, chloroethylene and trichloroethylene.

In preparing the dispersion for forming the upper charge generation layer, the ratio by mass of the binder to the charge-generating material is preferably from 1/20 to 20/1 or so, more preferably from 1/3 to 3/1. When the ratio is smaller than 1/20, then the binding force of the layer may be low; and when it is larger than 20/1, then the electric characteristics of the layer may worsen. The concentration of the solid matter in the dispersion for the upper charge generation layer is preferably from 1 to 30% by mass or so. When it is less than 1% by mass, then the layer may be too thin and it could not have the necessary electric characteristics; and when more than 30%, then the viscosity of the dispersion may be too high and the intended film could not be formed.

In particular, in order to disperse the high-sensitivity charge-generating material that contains a phthalocyanine having the above-mentioned specific crystal structure, the binder resin is preferably a polyvinylbutyral resin and the solvent is preferably any of 1-butanol, 3-methyl-3-hydroxy-2-butanone and 4-methyl-4-hydroxy-2-pentanone. In this preferred combination, the charge-generating material may be well dispersed, and this is extremely effective.

As the substrate of the photoconductive switching element of the invention, usable are glass, PET (polyethylene terephthalate), PC (polycarbonate), polyethylene, polystyrene, polyimide, PES (polyether sulfone). In particular, PET is preferred as it is inexpensive and has high strength. In case where an organic material is used in the photoconductive layer (charge generation layer, charge transport layer), then it does not require high-temperature heat treatment. In such a case, therefore, a light-transmissive plastic substrate is advantageously used, since it may be a flexible substrate and may be easily shaped and since its cost is low. In general, the thickness of the substrate is preferably from 10 μm to 500 μm or so, more preferably from 25 μm to 250 μm, even more preferably from 50 μm to 150 μm. As the electrode layer in the invention, usable are an IZO film, an ITO film, and SnO₂, Au, Al, Cu, Cr, etc. The substrate and the electrode may not always be transmissive to light. For example, when the display element of a photo-writing type recording medium has a memory function and when the display element is a selectively-reflecting or backward-reflecting element capable of selectively reflecting the wavelength of light necessary for display, as in JP-A-2001-100664, then it is possible to write on it on its display side; and therefore in this case, at least the substrate on the display element side and the electrode may be transmissive to light. Accordingly, in case where photo-writing is attained on the display element side, then the substrate or the electrode layer of the photoconductive switching element is not required to be transmissive to light; and a metal layer of Al, Cu, Cr, Au or the like may be used as the electrode layer in the case.

In the photoconductive switching element of the invention in which the upper and lower charge generation layers formed on and below the charge transport layer do not have the same photoconductive characteristics, a functional film having a capacity component capable of removing a direct current component from the element, or that is, a functional film for direct current component removal is preferably disposed, as in JP-A-2000-180888, paragraphs [0022] to [0025]. Having such a functional film, the photoconductive switching element may remove an effective direct current bias from it.

Apart from the functional film for direct current component removal, the element may also have any other functional film disposed therein. For example, a layer to prevent carrier invasion may be formed between the electrode and the charge generation layer. In addition, a reflective film or a light-shielding film may be formed, and a functional film having a plurality of such functions may also be formed. The functional films may be applicable to the element not significantly interfering with the current flow through the element. Regarding the structure of the photoconductive switching element of the invention, a charge generation layer may be formed between charge transport layers, and the element may have a structure of charge generation layer/charge transport layer/charge generation layer/charge transport layer/charge generation layer.

The photoconductive switching element of the invention has excellent voltage symmetry when an AC field is applied thereto, and can be produced in a high-speed continuous coating line. In addition, since the adhesiveness between the adjacent layers of the element is excellent, the element may have high quality and may be produced at low cost. Moreover, the photoconductive switching element has little charge trapping owing to delamination or layer defects, its functions do not deteriorate.

The photoconductive switching element may be used, as electrically connected to a functional element described below. The photoconductive switching element and the functional element may be connected in series or in parallel to each other, and the connection mode may be a combination of the two. In addition, the elements may be further connected to any other element. The functional element includes display elements such as liquid-crystal display elements for image display, electrochromic elements, electrophoretic elements, electric field rotation elements, space modulation elements, optical computing elements not for image display, memory elements for memory devices, and image-recording elements for thermal head. The photoconductive switching element of the invention is effective for switching of image display elements, especially liquid-crystal display elements. In case where the invention is applied to a liquid-crystal display element, it may act as a photo-writing type liquid-crystal space modulation element. In particular, AC driving is basic to a liquid-crystal display device, for which a direct current component is undesirable as so mentioned in the above, and therefore the photoconductive switching element of the invention is effectively applied to the device. In the device, usable are nematic, smectic, discotic and cholesteric liquid crystals.

As the functional element to which the invention is applicable, also mentioned is a memory functional element. One example of the memory functional element is a memory-functional liquid-crystal element, a type of the above-mentioned liquid-crystal display element. The memory-functional liquid crystal is characterized in that, when the liquid crystal is subjected to orientation control by voltage application thereto, the liquid crystal orientation is kept as such for a predetermined period of time even after the voltage application is removed. For example, it includes a polymer dispersion liquid crystal (PDLC), a ferroelectric liquid crystal having a chiral-smectic C phase, and a cholesteric liquid crystal. In addition, the invention is also applicable to capsule liquid-crystal elements obtained by encapsulating the above elements. Owing to its memory function, the memory-functional liquid crystal does not require an electric power for image display retention; or as integrated with any other element to construct a device to be mentioned hereinunder, it may be separately driven from the main body of the device. In addition, the device may be produced at low cost. Further, the memory-functional display element includes electrochromic elements, electrophoretic elements and electric field rotation elements, in addition to the above-mentioned liquid-crystal display elements.

In case where the photoconductive switching element of the invention is connected to a functional element such as that mentioned in the above, then these are preferably integrated into a device. As integrated together, the connection between the photoconductive switching element and the functional element may be kept stable. In particular, it is effective to integrate the photoconductive switching element with a memory-functional element. The device constructed by integrated these may be driven, as separated from the main body in which is it driven. Accordingly, for example, the device separated from the main body may be distributed. In addition, users may use it in any desired manner in a free space. As the case may be, however, it may be often difficult to ensure the reliability in again connecting the functional element and the photoconductive switching element after once separated from each other. Accordingly, an integrated device of the functional element and the photoconductive switching element is more preferred. The integrated device of the memory-functional liquid-crystal element, a type of the above-mentioned memory-functional element, and the photoconductive switching element (image-display medium) is especially effective as the device of the invention. Further, of the memory-functional liquid-crystal element, a cholesteric liquid crystal has high reflectivity and excellent display performance; and therefore, a device constructed by integrating such a cholesteric liquid-crystal display element and the photoconductive switching element is especially desirable as the image-display medium. Further in the invention, it is advantageous to construct a device by integrating the photoconductive switching element, the functional film for direct current component removal and the functional element, as laminated in that order. In the device in which the photoconductive switching element and the functional element are connected in series to each other, a functional film may be additionally provided between the upper charge generation layer of the photoconductive switching element and the functional element. For example, the additional functional film includes a separation layer for separating the photoconductive switching element from the functional element, and a functional film for direct current component removal.

One example of the device constructed by integrating the photoconductive switching element of the invention and a functional element is shown in FIG. 2, which is a conceptual view of a photo-writing type space modulation device having a functional film such as that mentioned in the above (photo-writing type recording medium). The photo-writing type recording medium 20 comprises a photoconductive switching element 30, a display element 40 and a functional film 50 sandwiched between the photoconductive switching element and the display element. In this, the photoconductive switching element 30 comprises a substrate 31, an electrode 32, a lower charge generation layer 33, a charge transport layer 34 and an upper charge generation layer 35; and the display element 40 comprises a substrate 41, an electrode 42 and a display layer (e.g., liquid-crystal layer) 43. As is obvious from the drawing, the upper charge generation layer 35 is positioned on the display element side. In the photo-writing type recording medium 20, it is necessary that, depending on whether the photo-writing is attained on the side of the photoconductive switching element or on the side of the display element, the substrate and the electrode of the element, on which the photo-writing light is incident to the device, are transmissive to light. An AC field is applied between the electrodes 32 and 42.

In the invention, the integrated device of the photoconductive switching element and the functional element as above is electrically connected to a driving mechanism for driving the device, thereby constructing an apparatus that exhibits various functions. In this embodiment, the driving mechanism may be provided, as separable from the integrated device. In this, the device may be separated from the main body thereof and may be used for reading the data therein, or may be distributed alone. The functional element may be any of a memory-functional element, a display element, a memory-functional display element, a liquid-crystal display element, a memory-functional liquid-crystal display element or a cholesteric liquid-crystal display element, but is preferably a memory-functional element, for example, a memory-functional liquid-crystal display element, more preferably a cholesteric liquid-crystal display element. In case where the device having the constitution as above is provided with a functional film for direct current component removal such as that mentioned in the above, then the voltage symmetry of the device in driving it in an AC field may be further improved.

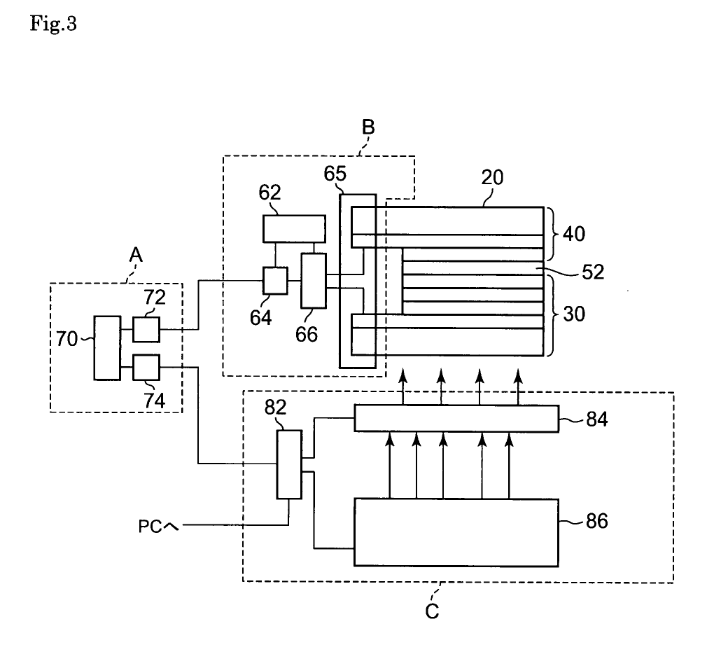

A display device that may be produced according to the invention is described. FIG. 3 shows an outline view of one example of the display device. The display device of FIG. 3 comprises a recording medium-driving system, a photo-writing system and a control system for controlling them. These systems may be integrated into one, or may be separated from each other. The recording medium-driving system comprises a wave generation unit 62, an inputted signal detection unit 64, a control unit 66 and a connector 65. The connector 65 is for connecting the transparent electrode on the substrate of the photoconductive switching element to the electrode on the substrate of the display element, and this has contact points on each side. Thus designed, the recording medium-driving system is separable from the photo-writing type recording medium 20. The photo-writing system comprises a control unit 82, an optical pattern formation unit (e.g., transmissive TFT liquid-crystal display) 84 and a light emitting unit (e.g., halogen light source) 86, in which the control unit 82 is connected to PC. The control system is for controlling the above-mentioned, recording medium-driving system and photo-writing system, and comprises a control unit 70, a driving wave generation signal outputting unit 72, and a photo-written data-inputting unit 74. In this embodiment, the photo-writing type recording medium 20 is provided with a functional film 52 for direct current component removal, between the photoconductive switching element 30 and the display element 40.

As synchronized with the photo-writing function of the photo-writing unit, a voltage application unit (not shown) for applying a driving pulse for display to the apparatus has a pulse generation unit and a trigger input detection unit for data outputting. To the pulse generation unit, for example, applicable is a system that comprises a waveform memory unit such as ROM, a DA conversion unit and a control unit and acts for DA conversion of the waveform read from ROM under voltage application thereto, thereby applying it to a space modulation device. Apart from it, also applicable thereto is a system capable of generating a pulse according to an electric circuit system such as a pulse generation circuit but not ROM. Not limited to these, in addition, any other system capable of imparting a driving pulse to the apparatus is employable herein with no specific limitation. The writing system has a unit for forming a pattern of the light to be emitted on the light incident side of the space modulation device, and a light emitting unit for transmitting the pattern to the space modulation device. For pattern formation, for example, employable is a transmission-type display such as a TFT-having liquid-crystal display or a simple matrix-type liquid-crystal display. As the light-emitting unit, usable is any one capable of emitting light to the space modulation device, such as a fluorescent light, a halogen lamp, an electroluminescent (EL) light. Needless-to-say, also employable herein are light-emitting type displays having both a pattern-forming function and a light-emitting function, such as EL displays, CRT, field emission displays (FED). In addition to those mentioned in the above, any other devices are also employable herein, capable of controlling the quantity of light to be emitted, the wavelength thereof and the light-emitting pattern to be given to the space modulation device.

The driving method for driving the functional element in the invention is not specifically defined, to which, for example, AC voltage, frequency, quantity of light emission and wavelength control are applicable. The voltage to be applied to the recording apparatus and the recording method of the invention is an AC voltage, and its waveform may be a sine wave, a rectangular wave or a triangular wave. Needless-to-say, these waves may be combined in any desired manner with no problem, or that is, any and every waveform with no specific limitation is applicable to the invention. For improving the display performance of the device of the invention, a sub-pulse that could not attain display switching by itself may be added to the driving pulse. To some display elements, impartation of some bias component may be effective, and needless-to-say, it may also be employed in this invention.

### EXAMPLES

An example of the photoconductive switching element of the invention is demonstrated below, which comprises a lower charge generation layer, a charge transport layer and an upper charge generation layer as laminated together to be in direct contact with each other. This is to more concretely disclose the characteristics of the invention. In the following Examples, the material used, its amount and the ratio, the details of the treatment and the treatment process may be suitably modified or changed not overstepping the sprit and the scope of the invention. Accordingly, the invention should not be limitatively interpreted by the Examples mentioned below. In the following, “%” and “part” are by mass.

### Test Example 1

### Confirmation of Solvent Capable of Swelling or Dissolving Charge Generation Layer

In this, a more simplified sample of a photoconductive switching element was prepared as follows: Chlorogallium phthalocyanine and polyvinylbutyral (Sekisui Chemical Industry's Eslec B BH-3) were mixed in 1-butanol at a concentration of 4%, and dispersed for 1 hour with a paint shaker, and the resulting coating liquid was continuously applied onto a transparent PET substrate according to a bar-coating process, thereby forming thereon a charge generation layer having a thickness of 0.5 μm. The sample was dipped in various solvents, and the charge generation layer was checked for dissolution. Since the charge generation layer was colored in blue, its dissolution may be easily detected. The solvents tested in the dissolution test are 1-butanol, methylene chloride, tetrahydrofuran (THF), toluene, cyclohexanone. The results are shown in Table 1. The charge generation layer could not be checked for swelling, as it was thin.

### Test Example 2

### Confirmation of Solvent Capable of Swelling or Dissolving Charge Transport Layer

In this, a more simplified sample of a photoconductive switching element was prepared as follows: A charge-transporting material, N,N-bis(3,4-ethylphenyl)biphenyl-4-amine, and a binder resin, polycarbonate bisphenol-Z (poly-4,4′-cyclohexylidene-diphenylene carbonate, Mitsubishi Gas Chemical's Z-400) were mixed in a ratio of 4/6 by mass, and dissolved in methylene chloride at a concentration of 30%, and the resulting coating liquid was continuously applied onto a transparent PET substrate according to a die-coating process, thereby forming thereon a charge transport layer having a thickness of 10 μm. The sample with the charge transport layer formed thereon was dipped in various solvents, and the charge transport layer was checked for swelling or dissolution. The solvents tested are 1-butanol, methylene chloride, tetrahydrofuran (THF), toluene, cyclohexanone. The results are shown in Table 1.

TABLE 1

| | Dissolution of | Swelling or |
|---|---|---|
| | Charge Generation | Dissolution of Charge |
| | Layer | Transport Layer |
| 1-Butanol | dissolved | not swollen |
| Methylene Chloride | dissolved | dissolved |
| THF | dissolved | dissolved |
| Toluene | not dissolved | dissolved |
| Cyclohexanone | not dissolved | dissolved |

### Example 1

### Formation of Photoconductive Switching Element

For evaluating the interlayer adhesiveness level of the photoconductive switching element of the invention, an OPC cell was prepared as follows: Hydroxygallium phthalocyanine having a peak at a Bragg angle of 7.5°, 9.9°, 12.5°, 16.3°, 18.6°, 25.1° and 28.3° in X-ray diffractiometry was used as a charge-generating material; and polyvinylbutyral was used as a binder resin. These were mixed in a ratio by mass of 1/1 in 1-butanol (concentration, 4%), and then dispersed for 1 hour with a paint shaker, thereby preparing a dispersion. The dispersion was applied onto a 125 μm-thick, ITO-coated PET film (Toray's Highbeam) on its ITO side, and then dried to form thereon a lower charge generation layer having a thickness of 0.2 μm.

A solution for charge transport layer was prepared as follows: A charge-transporting material, N,N-bis(3,4-ethylphenyl)biphenyl-4-amine, and a binder resin, polycarbonate bisphenol-Z (poly-4,4′-cyclohexylidene-diphenylene carbonate, Mitsubishi Gas Chemical's Z-400) were mixed in a ratio of 4/6 by mass, and dissolved in a mixed solvent of toluene/methylene chloride (1/1 by mass) to prepare a 20% solution. In this mixed solvent system, methylene chloride corresponds to the solvent capable of swelling or dissolving the directly-underlying charge generation layer. The solution was continuously applied onto the above coated film, at a speed of 5 m/min according to a die-coating process, and dried at 80° C., thereby forming a charge transport layer having a thickness of 8 μm on the lower charge generation layer.

A dispersion for upper charge generation layer was prepared as follows: Hydroxygallium phthalocyanine having a peak at a Bragg angle of 7.5°, 9.9°, 12.5°, 16.3°, 18.6°, 25.1° and 28.3° in X-ray diffractiometry was used as a charge-generating material; and polyvinylbutyral was used as a binder resin. These were mixed in a ratio by mass of 1/1 in 1-butanol (concentration, 4%), and then dispersed for 1 hour with a paint shaker, thereby preparing a dispersion. Methylene chloride was added to the dispersion in an amount of 10% by mass of 1-butanol therein, and mixed to prepare a coating solution. Methylene chloride is the solvent capable of swelling or dissolving the directly-underlying charge transport layer. The coating liquid was applied onto the above-mentioned, charge transport layer-coated support, according to a die-coating process, and dried to form thereon an upper charge generation layer having a thickness of 0.2 μm.

### (Delamination Test)

The photoconductive switching element was cross-cut at intervals of 2 mm in the crossing directions on its surface to such a degree that it could not be cut away into pieces. A masking tape (Nitto Denko's No. 720) was stuck to the sample, and rapidly peeled away, whereupon the sample was checked for delamination. As a result, no delamination was seen in the sample.

### Comparative Example 1

### Formation of Photoconductive Switching Element

In the same manner as in Example 1, a comparative OPC cell was prepared as follows: Hydroxygallium phthalocyanine having a peak at a Bragg angle of 7.5°, 9.9°, 12.5°, 16.3°, 18.6°, 25.1° and 28.3° in X-ray diffractiometry was used as a charge-generating material; and polyvinylbutyral was used as a binder resin. These were mixed in a ratio by mass of 1/1 in 1-butanol (concentration, 4%), and then dispersed for 1 hour with a paint shaker, thereby preparing a dispersion. The dispersion was applied onto a 125 μm-thick, ITO-coated PET film (Toray's Highbeam) on its ITO side, and then dried to form thereon a lower charge generation layer having a thickness of 0.2 μm.

A solution for charge transport layer was prepared as follows: A charge-transporting material, N,N-bis(3,4-ethylphenyl)biphenyl-4-amine, and a binder resin, polycarbonate bisphenol-Z (poly-4,4′-cyclohexylidene-diphenylene carbonate, Mitsubishi Gas Chemical's Z-400) were mixed in a ratio of 4/6 by mass, and dissolved in a solvent of toluene to prepare a 20% solution. The solvent does not contain a solvent capable of swelling or dissolving the directly-underlying charge generation layer. The solution was continuously applied onto the above coated film, at a speed of 5 m/min according to a die-coating process, and dried at 80° C., thereby forming a charge transport layer having a thickness of 8 μm on the lower charge generation layer.

A dispersion for upper charge generation layer was prepared as follows: Hydroxygallium phthalocyanine having a peak at a Bragg angle of 7.5°, 9.9°, 12.5°, 16.3°, 18.6°, 25.1° and 28.3° in X-ray diffractiometry was used as a charge-generating material; and polyvinylbutyral was used as a binder resin. These were mixed in a ratio by mass of 1/1 in 1-butanol (concentration, 4%), and then dispersed for 1 hour with a paint shaker, thereby preparing a dispersion. This coating liquid does not contain a solvent capable of swelling or dissolving the directly-underlying charge transport layer. The coating liquid was applied onto the above-mentioned, charge transport layer-coated support, according to a die-coating process, and dried to form thereon an upper charge generation layer having a thickness of 0.2 μm.

### (Delamination Test)

The photoconductive switching element was cross-cut at intervals of 2 mm in the crossing directions on its surface to such a degree that it could not be cut away into pieces. A masking tape (Nitto Denko's No. 720) was stuck to the sample, and rapidly peeled away, whereupon the sample was checked for delamination. As a result, the sample was delaminated at the interface between the lower charge generation layer and the charge transport layer.

### Example 2

In this Example, the photoconductive switching element prepared in Example 1 and Comparative Example 1 was integrated with a memory-functional display element, thereby constructing a photo-writing type recording medium for confirming its image display function.

### (Formation of Separation Layer)

On the upper charge generation layer of the photoconductive switching element prepared in Example 1 and Comparative Example 1, formed was a polyvinyl alcohol layer having a thickness of 0.2 μm according to a continuous die-coating process, which is a separation layer.

### (Formation of Display Element)

AS the display layer of the display element, used was a capsule liquid-crystal element prepared as follows: 21 parts of a chiral agent CB15 (by BDH) and 4.2 parts of a chiral agent R1011 (by Merck) were added to 74.8 parts of a nematic liquid crystal E8 having a positive dielectric anisotropy (by Merck), and melted under heat, and then restored to room temperature, thereby obtaining a chiral nematic liquid crystal capable of selectively reflecting a blue green color light. 3 parts of an addition product of xylene diisocyanate (3 mols) and trimethylolpropane (1 mol) (Takeda Chemical Industry's D-110N) and 100 parts of ethyl acetate were added to 10 parts of the blue green chiral nematic liquid crystal to prepare a uniform solution be an oily phase. On the other hand, 10 parts of polyvinyl alcohol (Kuraray's Poval 217EE) was added to 1000 parts of hot ion-exchanged water and stirred, and then left cooled to prepare a solution to be an aqueous phase.

Next, using a household mixer given AC 30 V with Slidac, the above aqueous phase was emulsified and dispersed in the above oily phase for 1 minute, thereby preparing an oil-in-water emulsion in which the oily phase was dispersed as droplets in the aqueous phase. The oil-in-water emulsion was stirred for 2 hours with heating in a water bath at 60° C., whereby the interfacial polymerization was completed to form liquid-crystal microcapsules therein. Thus formed, the mean particle size of the liquid-crystal microcapsules was estimated as about 12 μm with a laser particle sizer. The microcapsule dispersion was filtered through a 38 μm-mesh stainless screen, and the left as such for one full day. Then, the milky white supernatant was removed to obtain a microcapsule slurry having a solid content of about 40% by weight. A polyvinyl alcohol solution (10%) was added to the slurry in an amount of polyvinyl alcohol corresponding to 2/3 by mass of the solid content of the microcapsules in the slurry, thereby preparing a coating liquid for display layer. The coating liquid was applied onto a 125 μm-thick, ITO-coated PET film (Toray's Highbeam) on the ITO side thereof, using a wire bar of #44, thereby forming a liquid-crystal layer thereon. The process gave the intended display element.

### (Formation of Photo-Writing Recording Medium)

On the surface of the polyvinyl alcohol separation layer formed on the upper charge generation layer of the photoconductive switching element in the manner as above, a completely aqueous dry-lamination adhesive, Dicdry WS-321A/LD-55 (by Dai-Nippon Ink Chemical Industry) was applied and dried to form thereon an adhesive layer having a thickness of 4 μm. The adhesive layer of the photoconductive switching element was airtightly stuck to the liquid-crystal layer of the display element, and the two were laminated at 70° C. Then, a black polyimide BKR-105 (by Nippon Kayaku) was applied onto the surface of the PET film of the display element, and laminated to construct a photo-writing type recording medium for monochromatic display.

### (Blanking Test of Photo-Writing Type Recording Medium)

### (Recording Evaluation of Photo-Writing Type Recording Medium)

The photo-writing recording medium produced with the sample of Example 1 was connected to a photo-writing device as in FIG. 3, and voltage was applied to both electrodes of the photo-writing recording medium for monochromatic color image display. Four writing pulses of rectangular wave of 50 Hz, 4 pulses and 300 Vpp were applied to the device. As a result, the dark area (1 μw/cm²) and the exposed area (500 μw/cm²) gave a monochromatic image, in which the exposed area was blue and the dark area was black. After this, both edges of the recording medium in the longitudinal direction relative to the center part thereof were bent by ±10 mm repeatedly 500 times in total, and then the recording medium was tested for image display in the same manner as above. The recording medium did not change at all and had the same image as previously.

According to the invention, a photoconductive switching having improved adhesiveness at the interlayer of lower charge generation layer/charge transport layer and that of charge transport layer/upper charge generation layer, and having excellent workability and durability can be produced in a mode of continuous coating lamination. Combining the photoconductive switching element with various functional elements gives devices (e.g., photo-writing type recording medium) having good properties on the same level as that of conventional devices. According to the method of the invention, such a photoconductive switching element having excellent functions can be produced at low cost and at high speed; and the industrial applicability of the invention is great.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 256248/2006 filed on Sep. 21, 2006, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A method for producing a photoconductive switching element for switching a functional element to be driven by an AC field or a DC field, in which the photoconductive switching element comprises an electrode layer, a lower charge generation layer, a charge transport layer and an upper charge generation layer laminated in that order on a substrate, which comprises
forming at least one layer to be laminated above the electrode layer by the use of a solvent system that comprises a solvent capable of swelling or dissolving the layer just below the layer to be laminated.

2. The method for producing a photoconductive switching element according to claim 1, wherein the lower charge generation layer is positioned just below the charge transport layer, and the charge transport layer is formed by the use of a solvent system that comprises a solvent capable of swelling or dissolving the lower charge generation layer.

3. The method for producing a photoconductive switching element according to claim 2, wherein the charge transport layer comprises a charge-transporting material that comprises, as the main ingredient thereof, a benzidine compound and/or a triphenylamine compound, and a binder that comprises a polycarbonate resin as the main ingredient thereof, and a solvent system to be used in forming the charge transport layer comprises, as the main solvent thereof, at least one solvent selected from the group consisting of toluene, xylene, methylene chloride, dichloroethane, monochlorobenzene, tetrahydrofuran, cyclohexanone and cyclopentanone, and comprises, as the solvent capable of swelling or dissolving the lower charge generation layer, at least one solvent selected from the group consisting of methylene chloride, chloroform, chloroethylene, tetrahydrofuran and trichloroethylene.

4. The method for producing a photoconductive switching element according to claim 1, wherein the charge transport layer is positioned just below the upper charge generation layer, and the charge generation layer is formed by the use of a solvent system that comprises a solvent capable of swelling or dissolving the charge transport layer.

5. The method for producing a photoconductive switching element according to claim 4, wherein the upper charge generation layer comprises a charge-generating material that comprises, as the main ingredient thereof, at least one compound selected from the group consisting of chlorogallium phthalocyanine, hydroxygallium phthalocyanine and titanylphthalocyanine, and a binder resin that comprises, as the main ingredient thereof, at least one compound selected from the group consisting of a polyvinylbutyral resin, a polyvinylformal resin, a polyvinyl acetal resin and an alcohol-soluble nylon, and a solvent system to be used in forming the upper charge generation layer comprises n-butanol as the main solvent thereof, and comprises, as the solvent capable of swelling or dissolving the charge transport layer, at least one solvent selected from the group consisting of methylene chloride, chloroform, chloroethylene, trichloroethylene, toluene, xylene, cyclohexanone, methyl ethyl ketone and tetrahydrofuran, in an amount of at least 5% by mass of the overall solvent amount.

6. A photoconductive switching element produced by the method of claim 1.

7. A device comprising the photoconductive switching element of claim 6 and a functional element electrically connected to the photoconductive switching element.

8. A photo-writing type recording medium which comprises an electrode, a display layer, a photoconductive switching element and an electrode laminated between a pair of substrates, wherein
the photoconductive switching element is the photoconductive switching element of claim 6,
the upper charge generation layer of the element is positioned on the display layer side, and
the substrate and the electrode at least on the side on which writing light runs into it are transmissive to light.

9. A method for producing a photo-writing type recording medium for AC-driving system, which comprises
forming a charge-generating material-containing lower charge generation layer, a charge-transporting material-containing charge transport layer, and a charge-generating material-containing upper charge generation layer in that order to form a photoconductive switching layer on the surface of an electrode layer formed on a substrate, wherein each of the lower charge generation layer, the charge transport layer and the upper charge generation layer is formed by the use of a solvent system comprising a solvent capable of swelling or dissolving the layer just below the coating layer,
forming a display element layer on the surface of the transparent electrode layer of a transparent substrate having the transparent electrode layer formed thereon, and
laminating the thus-obtained two substrates in such a manner that the photoconductive switching layer and the display element layer could face each other.

10. A display device comprising the photo-writing type recording medium of claim 8, a recording medium-driving unit for driving the recording medium, a photo-writing unit for photo-writing on the recording medium, and a control unit.

11. A writing device comprising the photo-writing type recording medium of claim 8, a recording medium-driving unit for driving the recording medium, a photo-writing unit for photo-writing on the recording medium, and a control unit.
